(19) United States
(12) Patent Application Publication
(10) Pub. No.: US 2023/0256485 A1
(43) Pub. Date: Aug. 17, 2023

(54) SYSTEMS AND METHODS FOR DETECTING AND CLEANING CERTAIN SUBSTANCES

(71) Applicant: IoT Technologies LLC, La Jolla, CA (US)

(72) Inventor: Abraham GREENBOIM, La Jolla, CA (US)

(21) Appl. No.: 18/111,429

(22) Filed: Feb. 17, 2023

Related U.S. Application Data
(60) Provisional application No. 63/311,202, filed on Feb. 17, 2022.
(60) Provisional application No. 63/311,271, filed on Feb. 17, 2022.

(51) Int. Cl. B08B 13/00; B08B 3/02; B08B 1/00; B08B 5/04; G06V 20/10; G06V 20/17; B64U 10/00

(52) U.S. Cl. CPC B08B 13/00; B08B 3/02; B08B 1/002; B08B 5/04; G06V 20/176; G06V 20/17; B64U 10/00; B64U 2101/29

(57) ABSTRACT

A detector system for detecting at least one of dust, dirt, snow, and ice, comprising: one or more sensors configured to detect the at least one of dust, dirt, snow, and ice; and one or more processors configured to perform instructions, the instructions configured to cause the one or more processors to receive an indication from the one or more sensors relating to a detection of at least one of dust, dirt, snow, and ice, wherein the system comprises a light source, a dust panel, and a light detector.

### RELATED APPLICATIONS

This application claims priority under 35 U.S.C. § 119(e) to U.S. Provisional Patent Applications Ser. Nos. 63/311,202, filed Feb. 17, 2022, entitled “Systems and methods for Detecting Events using Data Classification” and 63/311,271, filed Feb. 17, 2022, entitled “Systems and Methods for Dust,” each of which is incorporated herein by reference in its entirety as if set forth in full.

### BACKGROUND

### I. Field of the Invention

The embodiments described herein are generally directed to, e.g., smoke, dust, dirt, snow or ice detection.

### II. Description of the Related Art

Smoke detectors are ubiquitous in all residential and commercial buildings; however, these detectors are designed to detect enough smoke to be indicative of a fire. These devices also have trouble distinguishing between dust, water vapor and smoke. Consequently, the detection threshold is set so that, e.g., household dust does not trigger an alarm.

Thus, there is not a commercially available sensor that can detect, e.g., smoke that would be indicative of someone smoking a cigarette. Hotels, for example are largely non-smoking. If someone does smoke in a room, it can leave behind a bad smell and lead to complaints from other guests. Consequently, hotels often will impose a fine if a guest is caught smoking in a non-smoking room. The problem is that conventional detectors may not be installed within rooms, may not be capable of detecting cigarette smoke, or may be in one room, while the user smokes in another.

Moreover, there is no commercially available detector that can be used to determine whether heating and air conditioning ducts or, e.g., filters included in such systems, should be cleaned. Conventionally, the home or building owner will simply rely on the advice of a professional, who has a vested interested in a certain outcome. While no one wants to live with ducts that need to be cleaned and that are not sufficiently filtering out dust and other particles.

People spend 90% of their time indoors inhaling up to 2700 gallons of air. But indoor air is 10 times more contaminated than outdoor air. In a typical home, the air we breathe comprises viruses, bacteria, odors, mold spores, volatile organic compounds (VOCs) such as formaldehyde and benzene, dust, pollen, pet dander, gaseous chemicals and particulate matter 2.5 microns (PM2.5) and smaller. In door pollutants and odors are often caused by smoking, cooking, combustion from wood stoves, fireplaces, gas stoves, building materials, human effluents/illness, lack of ventilation/stale air, cleaning chemicals, personal care products, paint, carpet, furniture, pollen, fungal spores, mold, and pets/pet dander. Pollutants and pathogens suspended in the air can be absorbed into our throats, eyes, lungs and blood stream, negatively impacting our health. Poor indoor air quality can lead to allergies, asthma, and even affect cognition and performance.

Moreover, Solar panels and many other objects can lose efficiency when they are dirty or covered in dust, snow, ice, etc. But such systems do not have mechanisms to detect, such substances.

### SUMMARY

The devices, systems and methods provided herein can advantageous detect dust, dirt, snow, ice, etc. on solar panels and other objects, and in some aspects, automatically cleans or initiate a cleaning of the solar panels without requiring a human to go onto the roof of a home, building, etc. to manually clean the panels. When reference is made to any of dust, dirt, snow or ice below, it should be appreciated that other unwanted items are contemplated as well. For example, when referring to a system detecting dust, it should be appreciated that the system could also be configured to detect snow, ice, and the like.

In some aspects, a detector system for detecting dust, dirt, snow, ice, etc. comprises one or more sensors (e.g., cameras, thermal camera, infrared sensors, laser sensors) configured to detect dust, dirt, snow, ice, etc., and one or more processors configured to perform instructions, the instructions configured to cause the one or more processors to receive an indication from the one or more sensors relating to a detection of dust, dirt, snow, ice, etc. (e.g., a detection of an amount of dust, for example, a thickness of dust, beyond a predetermined threshold). The system can comprise a wired or wireless communication interface. It is contemplated that the one or more sensors can be provided on a drone, a robot, an IoT device. For example, a drone can comprise one or more camera sensors and capture image data/photos of the solar panel or portions thereof.

In some aspects, an infrared (IR) light and/or IR sensor can be used to detect dust. For example, one or more IR phototransistors can be installed in different angles. It is contemplated that dust will shoot the IR signal back in many directions while clean panel will shoot only in one direction, allowing the system or user to detect dust and/or a level of dust. Similarly, it is contemplated that ultrasonic or laser sensors can be used. For example, an ultrasonic transceiver expects all signal to come back to measure correct distance when there is dust it will be scattered hence distance will change.

In some aspects, the instructions can be configured to cause the at least one of a drone, a robot, and an IoT device to clean at least a portion of the solar panels upon the detection of dust, dirt, snow, ice, etc. In some aspects, the instructions are configured to cause the drone or robot to spray a cleaning formulation onto at least a portion of the solar panels upon the detection of dust, dirt, snow, ice, etc. In some aspects, the instructions are configured to cause the one or more processors to communicate, via the communication interface to a platform, data relating to at least one of the indication and the cleaning (e.g., before and after images of the solar panels cleaned, video data, time data). In some aspects, the instructions are further to cause the at least one of a drone, a robot, and an IoT device to communicate, via the wired or wireless communication interface to a platform, data relating to a need for cleaning of at least a portion of the solar panels.

In some aspects, the one or more sensors are provided on a drone, and the one or more sensors comprises a camera to allow the drone to be manually deployed on adjacent solar panels. In some aspects, the layout of the solar panels or other objects to be monitored, and an area adjacent the solar panels or other objects to be monitored can be programmed into the system. The at least one of the drone, the robot, and the IoT device can be configured to autonomously deploy through the area adjacent the solar panels or even on the solar panels. A brush, vacuum or other cleaning component can be provided as a part of the system (e.g., on the drone) to clean dust, dirt, snow, ice, etc. detected on the solar panels.

In some aspects, the system can comprise one or more databases communicatively coupled to the one or more processors and configured to, among other things, store data relating to dust, dirt, snow, ice, etc. levels (e.g., image data corresponding to different levels of dirt or dust, pixel data, threshold dirt or dust data, laser sensor data, laser measurement data, infrared sensor data, infrared measurement data).

In some aspects, an IoT device can be placed on an edge portion of a solar panel and be connected to WiFi, zigbee, Bluetooth, or via some other shorter range wireless technology, or via 5G or some other cellular network technology.

In some aspects, a thermal camera can be provided, which allows the system to detect a malfunction in the solar panels.

In some aspects, machine learning is utilized to identify the need to clean a panel or other object. For example, the system can detect the cleanliness/dust, dirt, snow, ice, etc. level on the panels using machine learning by taking images of the panel and comparing them with image data corresponding to panels of different levels of cleanliness. In some aspects, using a simple IoT camera that is in the same or substantially the same angle as the solar panel, a system can periodically scan the pixels in the focal plan. A piece of glass (e.g., a 10 cm by 10 cm, or any other suitable size and shape) can be situated on top of the camera lens to increase the pixel scanned area. A level or progress of dust, dirt, snow, ice, etc., accumulated on the portion of the panel can be determined based on how dark one or more pixels corresponding to the portion of the panel becomes over time.

In some aspects, a level of dust, dirt, snow, ice, etc. on a solar panel can be determined based on an identification of dust, dirt, snow, ice, etc. on a camera lens or a material placed in front of the camera lens.

Also provided herein is a cleaning formulation configured to leave a layer of a catalyst (e.g., titanium oxide) on the solar panels or portion thereof to destroy dirt when it rains. Using weather forecast data, it is possible to know when it will likely rain. When the formulation is used in connection with a system as described herein, the instructions can further be configured to cause the formulation to be sprayed onto the solar panels or portion thereof (e.g., via the drone, robot, IoT device, another device adjacent the solar panels).

Also provided herein is a liquid cleaning formulation that can be sprayed (or otherwise dispensed) onto the solar panels or other object to be cleaned. In some aspects, no water is needed after the liquid cleaning formulation is sprayed. When the formulation is used in connection with a system as described herein, the instructions can further be configured to cause a squeegee, brush or other component to wipe over the portions of the solar panels the formulation was sprayed onto.

In some aspects, the system can comprise a scale to measure a weight of dust or dirt collected.

In some aspects, a light sensor can be provided below a transparent glass surface. One or more LED lights (e.g., an array) can be provided, for example, on top of the glass (or other similar material), and a light sensor can be provided, for example, below the glass and be connected to an IoT device (see, for example, FIG. 3). The light sensor can be used to measure or otherwise obtain data corresponding to the amount of light penetrating the glass, which can be used to determine the amount of dirt or dust on the glass. It is contemplated that the light measurement can be done at night with no added exterior light using the one or more LED lights. It is also contemplated that the device can be programmed to measure the amount of light penetrating the glass at any specific time(s)—such as the middle of the day without the use of LED lights.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a light sensor device for a detection system, according to an embodiment; and

FIG. 4 is a diagram illustrating a system for detecting flow information in accordance with one embodiment.

### DETAILED DESCRIPTION

In an embodiment, systems, methods, and non-transitory computer-readable media are disclosed for dust, dirt, snow, smoke, or ice, etc. detection and/or cleaning. An example platform on which the systems and methods can be implemented is described first, followed by a description of a processing system on which various aspects of the system can be implemented. The systems and methods are then described in the context of the platform and processing system.

After reading this description, it will become apparent to one skilled in the art how to implement the invention in various alternative embodiments and alternative applications. However, although various embodiments will be described herein, it is understood that these embodiments are presented by way of example and illustration only, and not limitation. As such, this detailed description of various embodiments should not be construed to limit the scope or breadth of the appended claims.

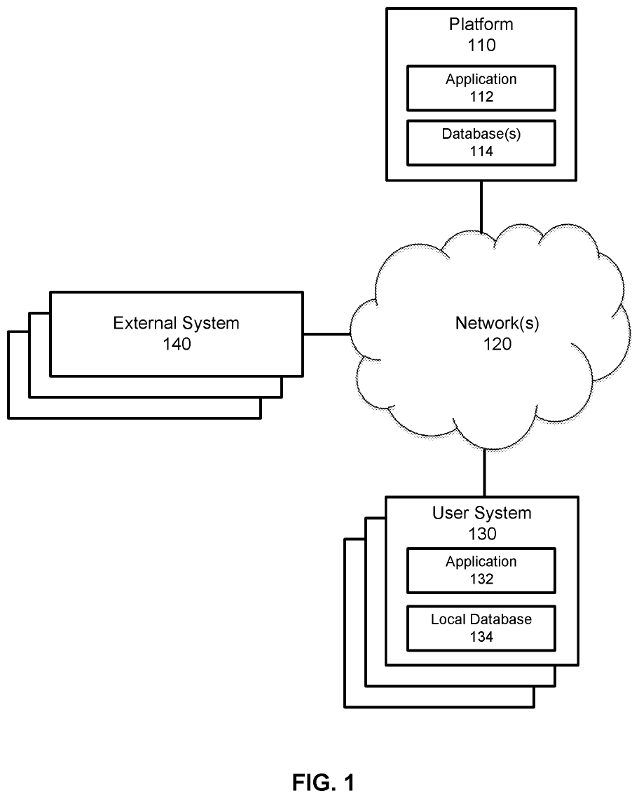

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™ Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130 and potentially using a local database 134, may interact with a server application 112 executing on platform 110 to execute one or more or a portion of one or more of the various functions, processes, methods, and/or software modules described herein. In an embodiment, client application 132 may utilize a local database 134 for storing data locally on user system 130. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions of the application described herein.

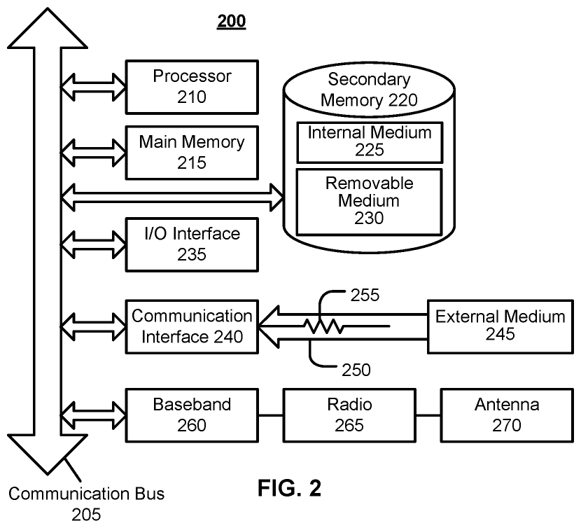

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., backend processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation CIC++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

Embodiments of processes for dust, smoke, dirt detection, detection of other substances, and/or cleaning will now be described in detail. It should be understood that the described processes may be embodied in one or more software modules that are executed by one or more hardware processors (e.g., processor 210), for example, as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

It should also be noted that some or all of the processing and control functions described herein, can be implemented at the edge, i.e., at the sensor or controller coupled therewith or at a user system 130.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In order to detect dust or dirt, e.g., on a solar panel, a detector can be deployed on or adjacent the solar panels. For example, the detector can be deployed to be on or adjacent the solar panels, at least 1, at least 2, at least 5, at least 10, or between 1-10 feet above solar panels, or in any other suitable location(s). In some aspects, the detector can be deployed such that it moves (e.g., rolls, travels, turns, pivots, rotates, flies) relative to a starting point. For example, the detector can compose a drone configured to hover or fly over the solar panels or portion thereof. The detector can act as a user system 130, although it may not contain a local database 134. But it can contain a processing system, with instructions and of course one or more sensors. The detector therefore can comprise a system 200 with one or more sensors interfaced, e.g., via I/O interface 235.

The sensor can be an optical based sensor. In certain embodiments, the detector system can actually comprise detection, filtering and cleaning capabilities.

The detector system can, when dust or dirt is detected (e.g., beyond a threshold amount), communicate such data, via communication interface 240 and/or radio 265. This can be, e.g., communicated back to a platform 110 operated by, or on behalf of an operator. Thus, platform 110 can generate a charge to an owner account (e.g., associated with an owner or manager of the solar panels) when dust is detected or cleaned. Moreover, platform 110 can store calibration and testing data to show that the detector systems are functional and functioning correctly in case someone challenges the charge.

The platform can also alert the owner or manager through a manager user system (e.g., that a charge will be applied to their account or bill, optionally including before and after cleaning image data with time data). Alternatively, or in addition, the service providers that provide cleaning services can be notified so they can contact the owner manager in order to set up service.

Or, as noted above, certain embodiments can also provide cleaning. For example, the detector system can comprise a brush, squeegee or other cleaning component, and/or store a cleaning formulation that can be sprayed or otherwise dispensed upon detection of dust or dirt (e.g., beyond a threshold amount), based on an event (e.g., a specified date or time, which may be recurring), or based on any other criteria.

The detector system can in certain embodiments be deployed via a drone or robot, which can comprise one or more cameras to allow the drone or robot to be manually deployed on and/or adjacent the solar panels. In some aspects, a layout of the solar panels and/or an area adjacent the solar panels can be programmed into the drone and/or the one or more cameras, and other sensors can be configured to allow the drone to autonomously deploy along a desired path where the solar panels or portions thereof can be monitored. The detector system can then report whether dust or other pollutants are too high. If deployed by a professional, the report can be fed back to a platform 110, which can generate a report for the customer.

In certain embodiments, instead of the detector system being included in or mounted on a drone or robot, the detector system can be installed on or adjacent the solar panels. An alert can then be generated for the home, building or structure owner, a professional or both.

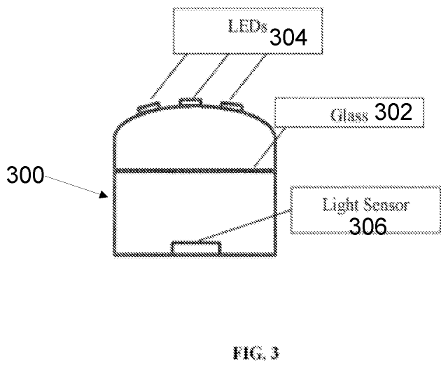

In some aspects, a light sensor can be provided below a transparent glass surface. One or more LED lights (e.g., an array) can be provided, for example, on top of the glass (or other similar material), and a light sensor can be provided, for example, below the glass and be connected to the drone or robot (or IoT device) (see, for example, FIG. 3). The light sensor can be used to measure or otherwise obtain data corresponding to the amount of light penetrating the glass, which can be used to determine the amount of dirt or dust on the glass. Thus, the detector system 300 can be deployed near the solar panel or other surface that may need to be cleaned. System 300 can be configured such that dust, snow, dirt, etc., can still fall on glass panel 302. Light form light source 304 can then be shined on glass 302, and detected by light sensor 306.

In some aspects, an infrared (IR) light and/or IR sensor can be used to detect dust. For example, one or more IR phototransistors can be installed in different angles. It is contemplated that dust will shoot the IR signal back in many directions while clean panel will shoot only in one direction, allowing the system or user to detect dust and/or a level of dust. Similarly, it is contemplated that ultrasonic or laser sensors can be used. For example, an ultrasonic transceiver expects all signal to come back to measure correct distance when there is dust it will be scattered hence distance will change.

In some aspects, the instructions can be configured to cause the at least one of a drone, a robot, and an IoT device to clean at least a portion of the solar panels upon the detection of dust, dirt, snow, ice, etc. In some aspects, the instructions are configured to cause the drone or robot to spray a cleaning formulation onto at least a portion of the solar panels upon the detection of dust, dirt, snow, ice, etc. In some aspects, the instructions are configured to cause the one or more processors to communicate, via the communication interface to a platform, data relating to at least one of the indication and the cleaning (e.g., before and after images of the solar panels cleaned, video data, time data). In some aspects, the instructions are further to cause the at least one of a drone, a robot, and an IoT device to communicate, via the wired or wireless communication interface to a platform, data relating to a need for cleaning of at least a portion of the solar panels.

In some aspects, the one or more sensors are provided on a drone, and the one or more sensors comprises a camera to allow the drone to be manually deployed adjacent solar panels. In some aspects, the layout of the solar panels or other objects to be monitored, and an area adjacent the solar panels or other objects to be monitored can be programmed into the system. The at least one of the drone, the robot, and the IoT device can be configured to autonomously deploy through the area adjacent the solar panels or even on the solar panels. A brush, vacuum or other cleaning component can be provided as a part of the system (e.g., on the drone) to clean dust, dirt, snow, ice, etc. detected on the solar panels.

In some aspects, the system can comprise one or more databases communicatively coupled to the one or more processors and configured to, among other things, store data relating to dust, dirt, snow, ice, etc. levels (e.g., image data corresponding to different levels of dirt or dust, pixel data, threshold dirt or dust data, laser sensor data, laser measurement data, infrared sensor data, infrared measurement data).

In some aspects, an IoT device can be placed on an edge portion of a solar panel and be connected to WiFi or cellular network.

In some aspects, a thermal camera can be provided, which allows the system to detect a malfunction in the solar panels.

In some aspects, machine learning is utilized to identify the need to clean a panel or other object. For example, the system can detect the cleanliness/dust, dirt, snow, ice, etc. level on the panels using machine learning by taking images of the panel and comparing them with image data corresponding to panels of different levels of cleanliness. In some aspects, using a simple IoT camera that is in the same or substantially the same angle as the solar panel, a system can periodically scan the pixels in the focal plan. A piece of glass (e.g., a 10 cm by 10 cm, or any other suitable size and shape) can be situated on top of the camera lens to increase the pixel scanned area. A level or progress of dust, dirt, snow, ice, etc., accumulated on the portion of the panel can be determined based on how dark one or more pixels corresponding to the portion of the panel becomes over time.

In some aspects, a level of dust, dirt, snow, ice, etc. on a solar panel can be determined based on an identification of dust, dirt, snow, ice, etc. on a camera lens or a material placed in front of the camera lens.

In some aspects, a light detector on, e.g., a moveable gear on the at least one of a drone, a robot, and an IoT device, can be used to point the device in the sun's direction, and collect direct sunlight into a photocell, in parallel the same light can be detected through the dust plane 306 into a separate photocell. By comparing the two photocells' readings we can evaluate the need for panel cleanups.

In other embodiments, a solar panel can be used to charge a battery connected with the at least one of a drone, a robot, and an IoT device. The charge efficiency over time will enable prediction of when cleanup is required. In other words, as the charge efficiency goes down over time, due to dust, etc., a threshold can be reached where cleaning is indicted as needed. The timing and threshold can change based on the substance. In other words, if it is snowing, the efficiency will deteriorate quickly potentially, whereas dust build up will take longer. The system can be interfaced with a weather API, e.g., associated with an external system 140, so that the system of device such that impending whether events can be known, and detection algorithms can be modified accordingly.

In certain embodiments, for example, if rain is expected, a cleaning agent, such as that described above can be deployed on the panels ahead of time, so that the rain will then result in the panels being cleaned.

Due to the tilted nature of solar panel installations, it is typical for the dust to accumulate towards the lower ⅓ of the panel. Thus, the dust panel 302, o rother detector can be tilted in the same angle and sun direction as the adjacent solar panel in order to collect accurate data.

As noted above, certain embodiments can also provide filtration and cleaning. For example, the detector system can comprise conventional air filtration, such as UV light, PCO and carbon filters, or more complex filtering technology such as bipolar ionization, which can remove smaller, more dangerous particles and, odors, and VOCs.

This is particularly useful for HVAC applications. Thus, a detector system can be deployed into ducts to detect whether dust and other pollutants are too high, or whether the condition of the air is excellent, good, light polluted, moderately polluted, heavily polluted, Severely and extremely polluted, etc. The detector system can in certain embodiments be deployed via a drone or robot, which can comprise a camera to allow the drone to be manually deployed throughout the duct system. Alternative, the layout of the duct system can be programmed into the drone and/or the camera and other sensors can be configured to allow the drone to autonomously deploy through the duct system. The detector system can then report whether dust or other pollutants are too high. If deployed by a professional, the report can be fed back to a platform 110, which can generate a report for the customer.

The drone or robot can also comprise a brush or vacuum to actual clean the dust within the ducts.

Other pollutants can include viruses, bacteria, odors, mold spores, formaldehyde, pet odor, chemicals, particulate matters over 2.5 micron, etc. If excessive levels of any of these types of pollutants are detected, then the report can so indicate. Moreover, the platform can recommend the appropriate remedial steps. Additional, components or systems can be included within the detector or drone/robot to assist with remediation.

In certain embodiments, instead of the detector system being included in or mounted on a drone or robot, the detector system can be installed within the duct next to the blower, or a vent in order to continuously monitor the dust and other pollutants within the system. An alert can then be generated for the homeowner, the professional or both.

In other embodiments, the need to change, e.g., an AC filter can be detected by deploying an accelerometer attached over spring design. Using ML classification, it can be determined when the flow goes through the filter and when the filter needs to be changed. The sensor can be attached to the back of the filter or anywhere within the duct. Such a sensor can be used to measure flow in air/gas or liquid pipes.

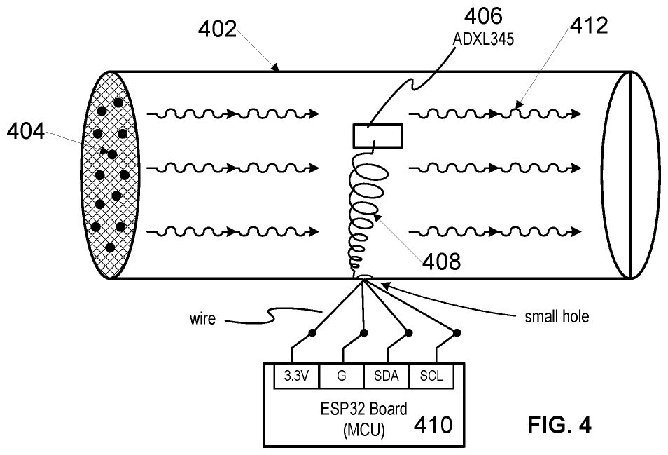

For example, as illustrated in FIG. 4, a duct 402 can house a filter 404. A sensor 406, such as an accelerometer, can be deployed within the duct 402 and attached to, e.g., a spring 408. The sensor 406 can be interfaced with a controller 410. As air 412 blows through filter 404, it will displace the sensor as a result of it being attached to the spring 408, or similar type of mechanism. When filter 404 is clean, the displacement will be great. As filter 404 gets dirtier and dirtier, the displacement will reduce. Once the displacement is reduced past a certain threshold, then it can be determined that the filter needs to be replaced.

Although not shown in FIG. 4, it is possible to use an external spring to extend the internal spring 408. Use of such an external spring would depend on the specific application and design requirements. The use of an external spring in this way could be useful in cases where the internal spring 408 does not provide enough mechanical force or displacement for the sensor 406 to function as intended.

In such cases, the external spring could be designed to work in series with the internal spring 408, providing additional mechanical force and extending the range of motion of the sensor 406. This approach can be particularly useful in cases where the design constraints limit the size and shape of the internal spring 408, but a larger range of motion or greater mechanical force is required.

However, as with using an external spring alone, incorporating an external spring to extend the internal spring 408 would require careful design considerations to ensure that the two springs work together seamlessly and do not introduce additional complexity or failure points in the system. Additionally, the use of an external spring could potentially increase the power consumption and reduce the reliability of the sensor 406, so it is important to carefully evaluate the trade-offs between performance, size, and power consumption.

For example, sensor 406 can be a vibration sensor with a MEMS accelerometer. Such sensors have an internal spring that may need to be augmented with an external spring to extend the sensitivity. Of course, detecting when a filter needs to be replaced as described above is just one application of such a sensor system. The fine tuning, e.g., vie the machine learning or other algorithms in the back end can overcome some of the potential issues that introduction of the external spring may introduce.

As noted above, platform 110 can be configured to notify service providers when solar panel cleaning is needed. Similarly, platform 110 can be configured to notify service providers when pollutants are present at elevated levels in a HVAC systems, or when a filter 404 needs to be replaced. In this way, platform 110 can act as a lead generation platform for contractors or service providers to provide the required services such as cleanup, general maintenance, and on-call service of the described equipment such as solar panels, AC systems, and Gas systems. Currently, most leads are generated using web content or web advertising, but this is inefficient at best. All sensors described herein including for leak detection, operation detection, etc., can be used as lead generators.

In order to detect smoke, e.g., cigarette smoke can be accomplished by deploying a highly sensitive detector, such as one or more sensors, such as described herein, combined with machine learning in the backend, within a room. For example, if it is a hotel room, the detector can be deployed within the main room or all rooms, including the bathroom. The detector can act as a user system 130, although it may not contain a local database 134. But it does contain a processing system, with instructions and of course one or more sensors. The detector therefore can comprise a system 200 with one or more sensors interfaced, e.g., via I/O interface 235.

The sensor can be an optical based sensor. In certain embodiments, the detector system can actually comprise detection, filtering and cleaning capabilities.

The detector system can, when smoke is detected, communicate such, via communication interface 240 and/or radio 265. This can be, e.g., communicated back to a platform 110 operated by, or on behalf of the hotel. Thus, platform 110 can generate a charge to the user's room account when smoke is detected. Moreover, platform 110 can store calibration and testing data to show that the detector systems are functional and functioning correctly in case a guest challenges the charge.

The platform can also alert management or security, so that they can warn the guest that smoking was detecting, and that a charge will be applied to their bill. If smoking is detected after the warning, increasing charges can be applied and ultimately the guest's stay can be terminated. Moreover, the guest can be banned from all locations for a brand or chain of restaurants.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, Conly, A and B, A and C, Band C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A detector system for detecting at least one of dust, dirt, snow, and ice, comprising: one or more sensors configured to detect the at least one of dust, dirt, snow, and ice; and one or more processors configured to perform instructions, the instructions configured to
cause the one or more processors to receive an indication from the one or more sensors relating to a detection of at least one of dust, dirt, snow, and ice, wherein the system comprises a light source, a dust panel, and a light detector.

2. The detector system of claim 1, further comprising a wired or wireless communication interface, and wherein the one or more sensors compose part of at least one of a drone, a robot, and an IoT device.

3. The detector system of claim 1, wherein the one or more sensors compose at least one of a drone, a robot, and an IoT device, and wherein the one or more sensors comprises a camera to allow the drone, robot or IoT device to be manually deployed adjacent solar panels.

4. The detector system of claim 3, wherein the layout of the solar panels and an area adjacent the solar panels can be programmed into the system, and wherein the drone or robot are configured to autonomously deploy through the area adjacent the solar panels.

5. The detector system of claim 2, wherein the at least one of a drone, a robot, and an IoT device also comprises a brush or vacuum to actually clean the at least one of dust, dirt, snow, and ice detected on an object.

6. The detector system of claim 1, wherein the detection of the at least one of dust, dirt, snow, and ice comprises detection of the at least one of dust, dirt, snow, and ice beyond a predetermined threshold amount.

7. The detector system of claim 1, further comprising one or more databases communicatively coupled to the one or more processors and configured to store data relating to at least one of dust, dirt, snow, and ice levels.

8. The detector system of claim 1, wherein the data relating to the at least one of dust, dirt, snow, and ice levels comprises image data.

9. The detector system of claim 1, wherein the data relating to the at least one of dust, dirt, snow, and ice levels comprises pixel data.

10. The detector system of claim 1, wherein the data relating to the at least one of dust, dirt, snow, and ice levels comprises at least one of laser and infrared measurement data.

11. The detector system of claim 3, wherein the instructions are further configured to cause the at least one of a drone, a robot, and an IoT device to clean at least a portion of the solar panels upon the detection of the at least one of dust, dirt, snow, and ice.

12. The detector system of claim 3, wherein the instructions are further configured to cause at least one of a drone, a robot, and an IoT device to spray a cleaning formulation onto at least a portion of the solar panels upon the detection of the at least one of dust, dirt, snow, and ice.

13. The detector system of claim 1, further comprising a wired or wireless communication interface, and wherein the instructions are further configured to cause the one or more processors to communicate, via the communication interface to a platform, data relating to at least one of the indication and the cleaning.

14. The detector system of claim 12, wherein the data relating to at least one of the indication and the cleaning comprises before and after image data.

15. The detector system of claim 3, wherein the instructions are further configured to cause the at least one of a drone, a robot, and an IoT device to spray a cleaning
